(19) United States
(12) Patent Application Publication
(10) Pub. No.: US 2007/0289076 A1
(43) Pub. Date: Dec. 20, 2007

(54) MOTORIZED FLUID DISPENSER AND METHOD OF USE THEREFOR

(76) Inventors: David J. Richmond, Los Angeles, CA (US); Howard Richmond, Los Angeles, CA (US)

Correspondence Address: ELIZABETH SWANSON;c/o SWANSON & ASSOCIATES, 9454 WILSHIRE BLVD., SUITE 500, BEVERLY HILLS, CA, 90212, US

(21) Appl. No.: 11/562,386

(22) Filed: Nov. 21, 2006

Related U.S. Application Data
(60) Provisional application No. 60/804,904, filed on Jun. 15, 2006.

(51) Int. Cl. G11B 23/50

(52) U.S. Cl. 15/97.1

(57) ABSTRACT

A motorized fluid dispenser is disclosed that provides a reservoir for retaining fluid, a dispensing end of the reservoir that opens onto an applicator, and a motor which provides movement to the applicator while the fluid is dispensed. The motor does not power fluid dispensing but provides movement of the applicator which, depending on the intended use of the fluid dispensed, may move the surface upon which the fluid is dispensed or may move the applicator relative to the surface. A cap is provided that physically prevents fluid from being dispensed while the cap is in place. The reservoir is adapted to withstand variations in temperature to permit immersion of the reservoir in a heated or cooling atmosphere or bath, and to withstand fluids that may be exothermic or endothermic.

### INCORPORATION BY REFERENCE

The inventors incorporate herein by reference any and all disclosure documents, U.S. patents, U.S. patent applications, and other documents, hard copy or electronic, cited or referred to in this application, including the disclosure document entitled VIBRATING MASSAGING DISPENSER APPLICATOR AND METHOD filed Jun. 16, 2006; U.S. Ser. No. 60/804,904 filed on Jun. 15, 2006 and entitled DISPENSER WITH MASSAGER AND METHOD; U.S. Ser. No. 11/155,015 filed Jun. 16, 2005 and entitled “TWIST-OPEN DISPENSER WITH APPLICATOR AND METHOD OF APPLYING SKIN CARE PRODUCTS & METHOD OF MERCHANDISING PAINT;” and U.S. Ser. No. 11/408,266 filed Apr. 20, 2006 and entitled “DISPENSER CAP AND DISPENSER.”

### BACKGROUND OF DEVICE AND METHOD OF THIS DISCLOSURE

Liquids with a viscosity higher than that of water may be referred to as creams, gels and lotions, or may be assigned functional names corresponding to their intended use, such as make-up, paint, degreaser, or arthritis relief cream. Such liquids are stored, contained and dispensed according to the volume of liquid needed and the nature of the surface treatment desired. For example, house paint may be dispensed both by pouring paint into a sprayer and then spraying it onto a surface, or by applying it with a roller, sponge or brush. As another example, skin care cream may be dispensed by pouring a small amount into a user's hand, onto an area of skin, or onto an applicator pad, and then manually massaging the cream into the user's skin.

When liquid products are applied to a surface, it may provide an advantage to provide motorized movement to the applicator during application. For some, the surface will be sufficiently pliable to be moved by the motorized applicator, while for other surfaces, the motorized applicator will move relative to the surface. For example, when applying a skin care cream to skin, a user's skin is typically pliable and may be massaged by the motorized movement of the applicator, for example while applying arthritis cream. When applying silver polish to a tarnished silver surface, the motorized applicator disclosed herein will typically move relative to the surface and thereby polish the silver during motorized application of the liquid.

### SUMMARY OF DEVICE AND METHOD OF THIS DISCLOSURE

This device and method of use provides, but is not limited to, a device and method for: applying a liquid to a surface while concurrently providing movement by a motor to the applicator; applying a skin care cream to the skin of a person and concurrently providing massaging movement of the applicator; providing a compact dispenser that vibrates including an applicator material that absorbs a viscous liquid as that liquid is being dispensed; and providing methods for dispensing different types of liquids containing active agents used for treatment, including but not limited to analgesics, exfoliating agents, dandruff treatments, muscle stimulating or relaxing agents, polishes, waxes, cleaners or other surface treatment products that are available in the form of a liquid.

### DESCRIPTION OF THE DRAWING

Some embodiments are disclosed in the accompanying drawing which includes the following figures (Figs.), with like numerals indicating like parts:

FIG. 1 is an exploded perspective view of one embodiment of the dispenser of this disclosure;

FIG. 2 is a partial exploded perspective view showing two components of the disclosed dispenser;

FIG. 3 is a partial exploded perspective view showing two components of the disclosed dispenser;

FIG. 4 is an exploded perspective view of three components of the disclosed dispenser;

FIG. 5 is a partial exploded perspective view showing two components of the disclosed dispenser;

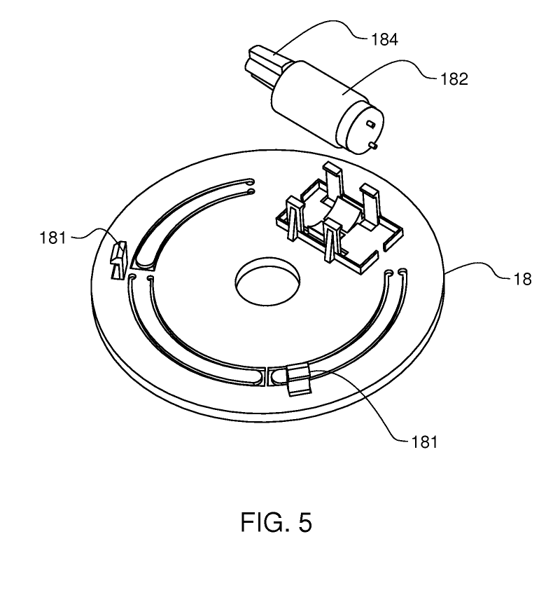

FIG. 6 is a partial exploded perspective view showing two components of the disclosed dispenser; and

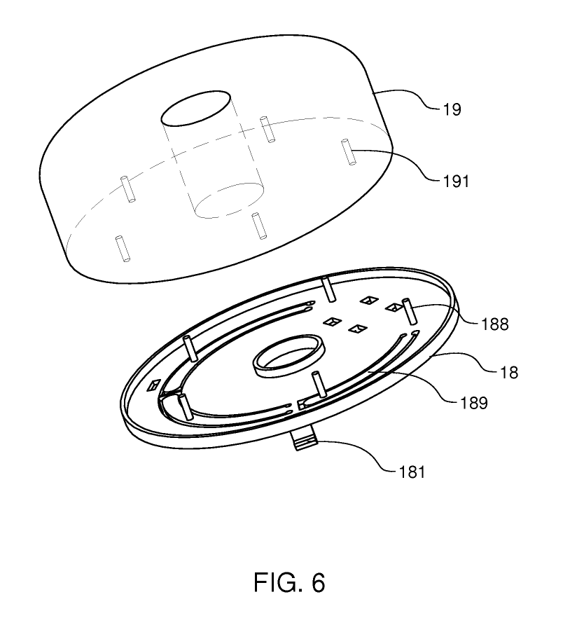

FIG. 7 is a section view of one embodiment of the dispenser of this disclosure.

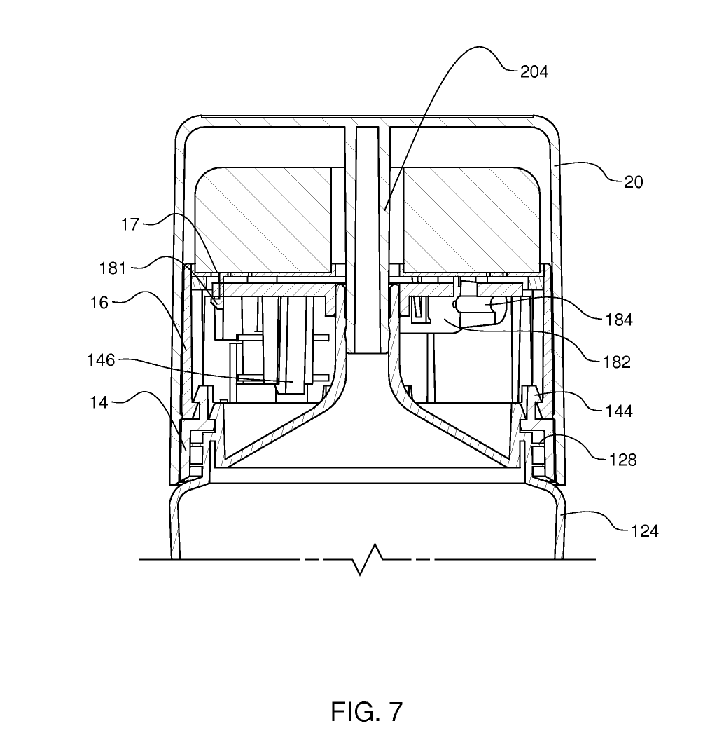

### DETAILED DESCRIPTION

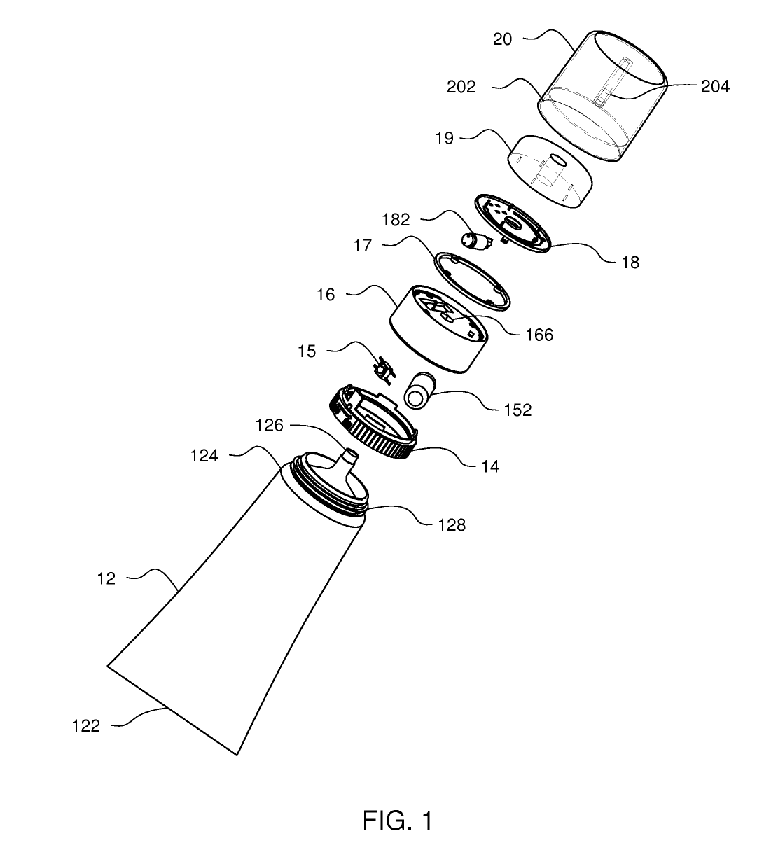

Referring to one embodiment of the device illustrated as FIG. 1, the fluid applicator 10 comprises a fluid reservoir 12 having a closed end 122, a dispensing end 124, and an opening 126 defined by the dispensing end 124; a housing 16 mounted onto the dispensing end 124 of the reservoir 12 onto which is attached a slideably mounted motor control member 14 and a detachably mounted enclosing cap 20. Also included in FIG. 1 are a micro-switch 15, a battery 152, a noise dampener 17, a motor 182, a holder 18, and a liquid applicator material 19.

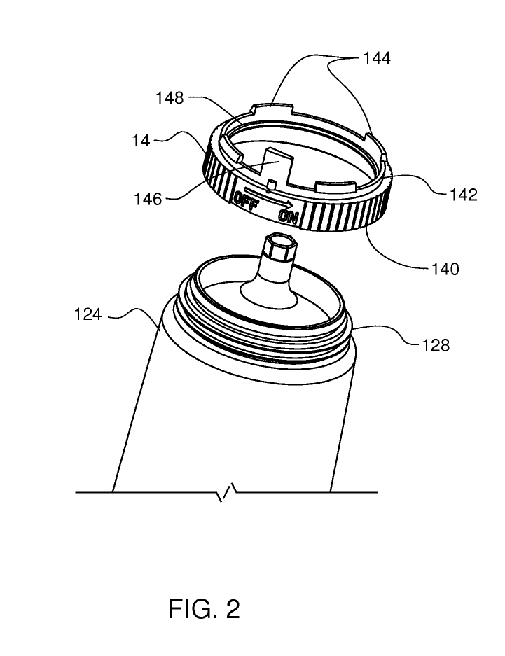

Referring to the embodiment of FIG. 2, the motor control switch 14 comprises an annular ring with a reservoir end 140 and an applicator end 142. One or more projections 144 are defined by the applicator end 142 which projections 144 are adapted to slideably mate with the housing 16. The reservoir end 140 of the motor control switch 14 is adapted to slideably mate with the dispenser end 124 of the reservoir 12.

In another embodiment, not shown, the motor control switch is slideably adapted to conform to a flat surface. In yet other embodiments, not shown, the motor control switch comprises a button, a knob, a dial, or a pressure sensitive control switch, or any switch design of the art. One feature common to the embodiments of motor control switches of this disclosure is that each is aesthetically adapted to the shape of the fluid reservoir or to the shape of the housing, and that such switch is adapted to effectively control at least one motor.

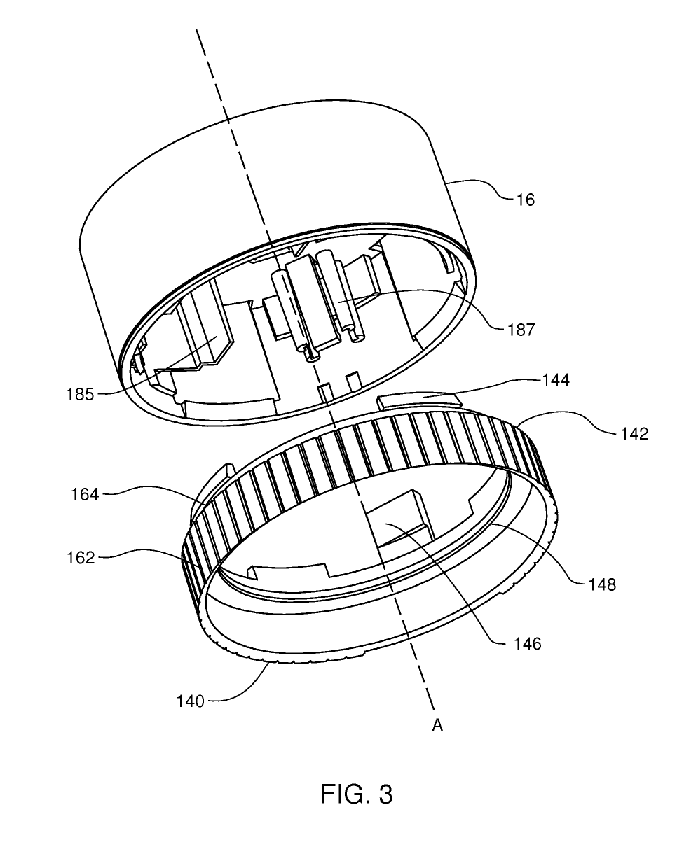

Referring now to the embodiment illustrated in FIG. 3, the housing 16 is adapted to slideably engage with the motor control switch 14 while the housing 16 remains fixedly engaged with the reservoir 12 during use. Such fixed engagement may be effected through a snug or snap fit between the reservoir opening 126 and an opening 166 defined by the housing 16. A spirally configured ridge 128 defined by the reservoir's dispenser end 124 mates with a corresponding spirally configured indent defined in the motor control switch 148. When the ridge 128 of the reservoir's dispenser end 124 is screwed into the motor control switch's indent 148, a moisture seal is created, while still permitting the motor control switch 14 to slideably mate either both the reservoir 12 and the housing 16. This seal serves as a barrier against liquids.

In an alternate embodiment, not shown, the motor control member may be slideably engaged with the reservoir by one or more annular ridge defined by the reservoir's dispenser end with mates with a correspondingly configured at least one annular indent defined in the motor control switch. In yet another embodiment, the housing and reservoir may be manufactured as a single piece, and so be permanently affixed to one another. In yet another embodiment, the housing and reservoir my be manufactured as separate components and then permanently attached to one another by any means known in the art, for example by adhesion or fusion. One common feature to each embodiment is that a moisture seal exists or is created by effecting a fixed engagement, with seal services as a barrier to liquids.

An enclosing cap 20 is provided having a sidewall 202 adapted to fit onto the dispensing end 126 of the reservoir 12. The enclosing cap 20 is also configured with an internal pin element 204 to engage with the dispenser 126 so as to block or prevent flow of fluid from the reservoir 12 when the enclosing cap 20 is fitted onto the reservoir 12. If there is a motor control switch 14 positioned between the housing 16 and reservoir 12, the enclosing cap 20 is also adapted to enclose the motor control switch 14 without affecting or effecting motor function. The enclosing cap 20 may be fitted onto or retained by the dispensing end 124 of the reservoir 12 through any means known in the are, including but not limited to snap fitting or screw fitting.

The fluid reservoir 12 is adapted to contain viscous fluid until the fluid is dispensed or applied. The reservoir 12 is also adapted to be deformed, squeezed, or to withstand applied pressure sufficiently well enough to enable such pressure to force fluid from the fluid reservoir member 12 out through the dispenser 126. Suitable containers include, but are not limited to, bottles, tottles (inverted bottles), and flexible tubes.

Further, the reservoir member 12 is adapted to withstand external temperature variations from about 0 degrees centigrade to about 100 degrees centigrade, and to transmit heat through its walls between fluid within the reservoir 12 and fluid in which the reservoir member 12 may be immersed. This permits fluid within the reservoir member 12 to be heated or cooled to a temperature that is appropriate for use of the fluid.

Still further, the reservoir member 12 is adapted to withstand internal temperature variations from about 0 degrees centigrade to about 100 degrees centigrade, so that any fluid contained within said reservoir member may undergo either an exothermic or an endothermic reaction within the reservoir 12 prior to application onto a user's skin or onto a surface to be treated.

Referring now to both FIGS. 2 and 3, the motor control switch 14 has a first end 140 adapted to slideably engage with the reservoir's dispensing end 124, and a second end 142 adapted to engage with the housing 16. In addition to the projections 144 described above, the second end 142 may also be adapted to provide one or more projections 146 adapted to engage a micro-switch 15. Such engagement enables the motor control member 14 to control the motor function of the disclosed applicator 10. The micro-switch may be a simple on/off switch or may vary the speed of the at least one motor 182 of the device 10.

In one embodiment, the reservoir 12 and enclosing cap 20 have a common diameter D1, while the motor control switch 14 and housing 16 each has a common diameter D2 in which D2 is less than D1. The difference in diameters between D1 and D2 vary depending upon the materials used for construction of the disclosed device, but are generally adapted to provide a snug fit of the enclosing cap 20 over the motor control switch 14 and housing 16.

In another embodiment, the reservoir 12, and enclosing cap 20 each has a cross section that defines a rectangle having an area A, a length L, a width W and a height H, while the motor control switch 14 and housing 16 each has a cross section that defines a circle with a diameter D3 that is less than either the length L or the width W.

Several embodiments are provided according to this disclosure, each of which provides that the external cross sectional dimensions of the reservoir 12 and enclosing cap 20 are approximately equal, and which provide that the external cross sectional dimensions of the motor control switch 12 and housing 16 are approximately equal, and that they are configured for enclosing cap by the enclosing cap 20.

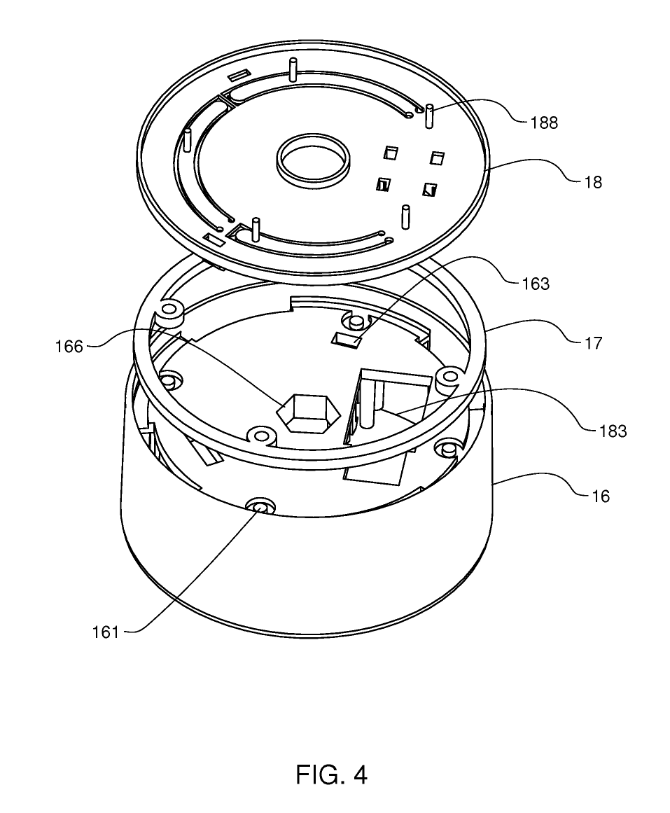

Referring now to embodiment illustrated in FIGS. 3 and 4, the housing 16 provides structural elements adapted to receive at least one motor 182, at least one battery 152, and at least one micro-switch 15. In the illustrated embodiment, these structural elements comprise a battery mount 185 and a micro-switch mount 187. There is additionally a motor cavity 183 defined by the housing 16 adapted to receive at least one motor 182.

The illustrated embodiment shown in FIG. 4 also reveals a noise dampener 17, in this embodiment a flattened ring, adapted to fit on noise dampener holders 161 spaced about the housing 16. More than one noise dampener 17 may be used. The noise dampener 17 is made of any material capable of absorbing and dampening vibrations produced by the at least one motor 182. In one embodiment, the noise dampener is comprised of acrylonitrile-butadiene rubber, commonly known as “NBR.” However, the noise dampener may be comprised of any substance that effectively reduces the noise made by the motor of the device.

Still in reference to the embodiment of FIG. 4, at least one channel 163 is defined by the housing 16 which at least one channel 163 mates with at least one holder flange 181 which projects from the holder 18. The holder is adapted to fixedly retain at least one motor 182 while the motor 182 is turned on and is vibrating.

One way of generating movement by the at least one motor 182 is to generate vibration. In the illustrated embodiment, the motor 182 comprises a rotatable drive shaft (not shown) upon which is mounted an eccentric weight 184. The rotating eccentric weight 184 vibrates the holder 18, but the vibrations to the housing and dampened by the noise dampener 17. A user holding the vibrating applicator 10 will sense various types of vibrations depending on the orientation of the motor 182 to the holder 17, the number of motors 182 used, and the manner in which vibration is effected by each motor used 182. Other types of motors may provide other types of movement to the holder, for example a rotating or circular movement, a percussive movement, a wave-like movement or any other type of movement capable of being generated by at least one motor.

The holder 17 is also adapted to hold a fluid applicator material 19, for example sponge. Other fluid applicator materials include but are not limited to brushes, pads, fabric, loofah, pumice, rubber, or any composition used in connection with applying fluid to a user or with massaging a user. Further, each applicator material may itself be modified to include adaptations that improve dispersion of liquid over the surface to which liquid is applied.

In one embodiment having as its reservoir a tube or other dispenser with a generally circular cross section, details are provided as follows. The motor control member 14 comprises an annular wall 162 with an exterior surface 164 adapted to be frictionally rotated by a user's fingers about an axis A. Housing engaging projections 144 are adapted to engage with motor control engagement slots 161 of the housing 16. The motor control switch 14 is further adapted to rotate about its axis A in either clockwise or counter clockwise directions.

When an engaging member 146 engages with the micro-switch 15 it powers the motor 180 by causing the member 146 to engage complete an electrical circuit, to break an electrical circuit or to change the resistance of an electrical circuit. The electrical circuit so affected comprises at least one battery 152, at least one motor 182 and at least one micro-switch 15, which components are connected as is common in the art. In the embodiment shown, the switch 178 is an on/off switch. In other embodiments, the switch 178 may comprise a speed control switch which enables a user to control the speed of the motor in addition to turning the motor off and on. Mechanisms for enabling the motor control switch 14 to rotate about its axis and effectuate the motor 180 are well known in the art, and any one of them may be applied to this disclosure yet remain within the scope of the disclosed device and method.

This device also includes method of topically applying a fluid to the skin of a person or to another surface using the dispenser 12 of this device of this disclosure. According to the method of this device of this disclosure, the enclosing cap 20 is removed and the fluid flows into or onto the applicator element 19, for example, by squeezing the reservoir 12. The fluid is applied to the skin of the person or other surface upon contact with the applicator element 19. Concurrently the motor 182 is actuated by the motor control member 14 as the fluid is being applied. Various types of fluid may be applied to the skin of the person or other surface using the method of this device of this disclosure, for example, a depilatory cream, a cream including an anti-arthritis agent, an exfoliating cream, an analgesic cream, a cream including an anti-cellulite agent, a cream including an agent to relieve muscle soreness, a deodorant cream, a polishing liquid, a cleaning liquid, a soap.

One feature of the method of this device of this disclosure is the use of a fluid that is free of water and includes an ingredient that reacts with water to produce heat. An example of a suitable ingredient is an anhydrous salt such as, for example, magnesium sulfate. Immediately before applying a anhydrous liquid containing an ingredient that reacts exothermically with water, the absorbent applicator element 19 is dipped, or otherwise treated with water, so as the anhydrous liquid flows into the applicator element, heat is liberated as the dispenser 10 moves.

What is claimed is:

1. A fluid dispenser comprising:
a fluid reservoir, the reservoir having a closed end and a fluid dispensing end; an assembly attached to the reservoir, the assembly comprising an applicator element adapted to receive fluid dispensed from the dispensing end of the reservoir and apply the fluid to a surface; and at least one manually controlled, battery powered motor mounted on the assembly, which motor causes the applicator to move when the motor is powered by the battery.

2. The fluid dispenser of claim 1 comprising a fluid reservoir dispensing end having a substantially circular cross section and an annular motor control switch slideably mounted on the assembly.

3. The fluid dispenser of claim 1 in which the motor control switch is slideably adapted to conform to a flat surface.

4. The fluid dispenser of claim 1 in which the motor control switch comprises a button.

5. The fluid dispenser of claim 1 in which at least one motor causes the applicator element to vibrate.

6. The fluid dispenser of claim 1 in which the motor causes the applicator to rotate.

7. The fluid dispenser of claim 1 in which at least one liquid barrier prevents liquid from contacting the battery and motor.

8. A fluid dispenser comprising:
a fluid reservoir having a closed end and a fluid dispensing end, an assembly attached to the reservoir, the assembly comprising an applicator element adapted to receive fluid dispensed from the dispensing end of the reservoir and apply the fluid to a surface; and at least one manually controlled motor mounted on the assembly, which motor causes the applicator to move when the motor is powered.

9. The fluid dispenser of claim 8 comprising a fluid reservoir dispensing end having a substantially circular cross section and an annular motor control switch slideably mounted on the assembly.

10. The fluid dispenser of claim 8 in which the motor control switch is slideably adapted to conform to a flat surface.

11. The fluid dispenser of claim 8 in which the motor control switch comprises a button.

12. The fluid dispenser of claim 8 in which at least motor causes the applicator element to vibrate.

13. The fluid dispenser of claim 8 in which the motor causes the applicator to rotate.

14. The fluid dispenser of claim 8 in which at least one liquid barrier prevents liquid from contacting the battery and motor.

15. A fluid dispenser comprising:
a fluid reservoir having a closed end and a fluid dispensing end, an assembly attached to the reservoir, the assembly comprising an applicator element adapted to receive fluid dispensed from the dispensing end of the reservoir and apply the fluid to a surface; at least one manually controlled, battery powered motor mounted on the assembly; and an enclosing cap that prevents liquid from being dispensed from the dispensing end of the reservoir when the cap is in place.

16. The fluid dispenser of claim 15 comprising a fluid reservoir dispensing end having a substantially circular cross section and an annular motor control switch slideably mounted on the assembly.

17. The fluid dispenser of claim 15 in which the motor control switch is slideably adapted to conform to a flat surface.

18. The fluid dispenser of claim 15 in which the motor control switch comprises a button.

19. The fluid dispenser of claim 15 in which at least one motor causes the applicator element to vibrate.

20. The fluid dispenser of claim 15 in which at least one motor causes the applicator element to rotate.

21. The fluid dispenser of claim 15 in which at least one liquid barrier prevents liquid from contacting the battery and vibrator.

22. The fluid dispenser of claim 15 in which the enclosing cap prevents liquid from being dispense from the dispensing end of the reservoir when the cap is in place by plugging the dispensing end of the reservoir with a pin.

23. The fluid dispenser of claim 15 in which the assembly is between the reservoir and the applicator, and a noise dampener is mounted between the assembly and the applicator.

24. The fluid dispenser of claim 15 in which the reservoir is between the motor and the applicator.

25. A method of topically applying a fluid to a surface comprising:
providing a fluid containing reservoir having a closed end and a dispensing end; providing fluid in the fluid containing reservoir; providing an assembly attached to the dispensing end of the reservoir, the assembly comprising an applicator adapted to receive fluid dispensed from the dispensing end of the reservoir and a manually operated, battery powered motor mounted on the assembly; and dispensing the fluid from the reservoir onto a surface by manually controlling the motor while contacting the applicator element with the surface.

26. The method of claim 25 in which the dispensed fluid is heated before application.

27. The method of claim 25 in which the dispensed fluid is cooled before application.
